(19) United States
(12) Patent Application Publication
(10) Pub. No.: US 2023/0322402 A1
(43) Pub. Date: Oct. 12, 2023

(54) OBSERVATION LOGGING VIA QR CODE FOR AIRLINE PERSONNEL

(71) Applicant: GOODRICH CORPORATION, Charlotte, NC (US)

(72) Inventors: JONATHAN WIDMER, Jamestown, ND (US); STEVE T. MCQUEEN, Jamestown, ND (US)

(73) Assignee: GOODRICH CORPORATION, Charlotte, NC (US)

(21) Appl. No.: 17/717,782

(22) Filed: Apr. 11, 2022

(51) Int. Cl. B64D 45/00; G06K 7/14; B64F 5/60; G01S 19/38

(52) U.S. Cl. CPC B64D 45/00; G06K 7/1443; B64F 5/60; G01S 19/38; G06F 3/0482

(57) ABSTRACT

A method of logging an observation or maintenance request of an aircraft, the method can comprise: scanning, by a personal internet device connected to a network, a machine-readable code; directing the personal internet device to a user interface of an aircraft log database based on the machine-readable code; and transmitting, by the personal internet device, a log entry to the aircraft log database over the network, wherein the log entry comprises a description of the observation. The method can further comprise transmitting an alert notification to an aircraft maintenance system. An aircraft log system can comprise a personal internet device, a machine-readable code disposed on an aircraft, and an aircraft log database. The aircraft log system can further comprise a manufacturer log database.

### FIELD

The disclosure generally relates to logging aircraft data methods, and, more specifically to methods and systems for logging observations and maintenance requests on aircraft.

### BACKGROUND

Aircraft personnel and crew often service aircrafts before and after each flight. The aircraft personnel and crew may observe issues with various areas of the aircraft, including but not limited to, the cargo bay and the galley of the aircraft. These observations may include issues to the aircraft that require maintenance. Reporting of these observations can be recorded in logbooks. However, these logbooks are often hard copies on paper and are not always easily accessible to aircraft personnel, maintenance crew and engineering. Once logbooks are located, the crew may fail to recall the exact observations they made earlier.

### SUMMARY

A method of logging an observation of an aircraft is disclosed herein. The method can comprise receiving, by an application server connected to a network, an observation log request from a personal internet device connected to the network. In various embodiments, the method can comprise transmitting, by the application server, an application data to the personal internet device. In various embodiments, the method can comprise receiving, by the application server, a log entry from the personal internet device, wherein the log entry comprises a notification request. In various embodiments, the method can comprise generating, by the application server, an alert notification based on the notification request. In various embodiments, the method can comprise transmitting, by the application server, the alert notification to an aircraft maintenance system in communication with the network.

In various embodiments, the log entry can comprise a user input data and a pre-populated data. In various embodiments, the user input data and the pre-populated data can comprise extensible markup language (XML) data. In various embodiments, the user input data can comprise a log description, the notification request and a name. In various embodiments, the log description can comprise an unstructured description, wherein the unstructured description can comprise a free text description of the observation. In various embodiments, the log description can comprise a structured description, wherein the structured description can comprise a drop-down menu for selecting the observation from a list of observations.

In various embodiments, the pre-populated data can comprise an aircraft report zone, an aircraft identifier, an observation date, and an observation time. In various embodiments, the personal internet device can comprise a global positioning system (GPS) location. In various embodiments, the pre-populated data can comprise an aircraft location based upon the GPS location of the personal internet device.

A method of logging an observation of an aircraft is disclosed herein. The method can comprise scanning, by a personal internet device in communication with a network, a machine-readable code coupled to a code display. In various embodiments, the method can comprise translating, by the personal internet device, the machine-readable code. In various embodiments, the method can comprise receiving, by the personal internet device, an application data from an application server in communication with the network. The application data can instruct the personal internet device to open a user interface. In various embodiments, the method can comprise generating, by the personal internet device, a log entry in the user interface. In various embodiments, the method can comprise transmitting, by the personal internet device, the log entry to an aircraft log database over the network. The log entry can comprise a notification request. In various embodiments, the method can comprise transmitting, by the personal internet device, the log entry to a manufacturer log database over the network.

In various embodiments, the log entry can comprise a user input data and a pre-populated data. In various embodiments, the user input data can the pre-populated data can comprise extensible markup language (XML) data. In various embodiments, the user input data can comprise a log description, the notification request, and a name. In various embodiments, the pre-populated data can comprise an aircraft report zone, an aircraft identifier, an observation date and an observation time. In various embodiments, the personal internet device can comprise a global positioning system (GPS) location. In various embodiments, the pre-populated data can comprise an aircraft location based upon the GPS location of the personal internet device.

An article of manufacture including a tangible, non-transitory computer readable storage medium having instructions stored thereon is disclosed herein. The tangible, non-transitory computer-readable storage medium having instructions stored thereon can, in response to execution by a processor, cause the processor to perform operations. In various embodiments, the operations can comprise receiving, by the processor, an observation log request from a personal internet device connected to a network. In various embodiments, the operations can comprise transmitting, by the processor, an application data to the personal internet device. In various embodiments, the operations can comprise receiving, by the processor, a log entry from the personal internet device. The log entry can comprise a notification request. In various embodiments, the operations can comprise generating, by the processor, an alert notification based on the notification request. In various embodiments, the operations can comprise, transmitting, by the processor, the alert notification to an aircraft maintenance system in communication with the network.

In various embodiments, the article of manufacture can be in communication with a manufacturer log database. In various embodiments, the operations can further comprise transmitting, by the processor, the log entry to the manufacturer log database.

### BRIEF DESCRIPTION OF THE DRAWINGS

The subject matter of the present disclosure is particularly pointed out and distinctly claimed in the concluding portion of the specification. A more complete understanding of the present disclosures, however, may best be obtained by referring to the detailed description and claims when considered in connection with the drawing figures, wherein like numerals denote like elements.

FIG. 1 illustrates an aircraft, in accordance with various embodiments;

FIG. 2 illustrates a cargo bay of an aircraft, in accordance with various embodiments;

FIG. 3 illustrates a block diagram for an aircraft log system, in accordance with various embodiments;

FIG. 4 illustrates a block diagram for an aircraft log system, in accordance with various embodiments;

FIG. 5 illustrates a block diagram of a log entry, in accordance with various embodiments;

FIG. 6 illustrates a method for logging an observation on an aircraft, in accordance with various embodiments; and

FIG. 7 illustrates a method for logging a maintenance task on an aircraft, in accordance with various embodiments.

FIG. 8 illustrates a user interface, in accordance with various embodiments.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the disclosures, it should be understood that other embodiments may be realized and that logical, chemical, and mechanical changes may be made without departing from the spirit and scope of the disclosures. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, “communication” means communication of electronic signals with physical coupling (e.g., “electrical communication” or “electrically coupled”) or without physical coupling and via an electromagnetic field (e.g., “inductive communication” or “inductively coupled” or “inductive coupling”). As used herein, “transmit” may include sending electronic data from one system component to another via electronic communication between the components. Additionally, as used herein, “data” may include encompassing information such as commands, queries, files, data for storage, and the like in digital or any other form.

As used herein, “personal internet device” any suitable hardware, software, and/or database components capable of sending, receiving, and storing data. For example, a personal internet device may comprise a personal computer, personal digital assistant, cellular phone, smartphone (e.g., IPHONE®, and/or the like), IoT device, and/or the like. The personal internet device may comprise an operating system, such as, for example, a WINDOWS® mobile operating system, an ANDROID® operating system, APPLE® IOS®, a LINUX® operating system, and the like. The personal internet device may also comprise software components installed on the personal internet device and configured to enable access to various system components. For example, the personal internet device may comprise a web browser (e.g., MICROSOFT INTERNET EXPLORER®, GOOGLE CHROME®, etc.).

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a personal internet device configured to add, delete, modify, or augment the data in accordance with the header or trailer. As such, in various embodiments, the header or trailer is not stored on the personal internet device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, personal internet device, online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and methods are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEB SPHERE® MQTM (formerly MQSeries) by IBM®, Inc. (Armonk, NY) is an example of a commercially available middleware product. An Enterprise Service Bus (“ESB”) application is another example of middleware.

The computers discussed herein may provide a suitable website or other internet-based graphical user interface (GUI) which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

As used herein, “machine-readable code” means any code which can contain unique information and data. The machine-readable code is configured to be scanned by the personal internet device using a camera or other sensor on the personal internet device. Some examples of a machine-readable code include but are not limited to quick response (QR) codes, radio frequency identification (RFID) and near-field communication (NFC). A QR code can be an image that is scanned by a camera on the personal internet device, while the RFID and NFC would be a non-computerized device that is embedded with a computing unit and is scanned by the personal internet device with an RFID reader or NFC reader. QR codes can transfer data information to the person internet device when scanned and can direct the personal internet device to a web domain.

Computer-based system program instructions and/or processor instructions may be loaded onto a tangible, non-transitory computer readable medium having instructions stored thereon that, in response to execution by a processor, cause the processor to perform various operations. The term “non-transitory” is to be understood to remove only propagating transitory signals per se from the claim scope and does not relinquish rights to all standard machine-readable media that are not only propagating transitory signals per se. Stated another way, the meaning of the term “non-transitory machine-readable medium” and “non-transitory machine-readable storage medium” should be construed to exclude only those types of transitory machine-readable media which were found in In re Nuijten to fall outside the scope of patentable subject matter under 35 U.S.C. § 101.

Various areas, including a cargo bay, a lavatory, and a galley of an aircraft, may be examined by airline personnel, engineers and crew to determine whether notable observations or maintenance tasks should be logged. A machine-readable code can be scanned by a personal internet device at a location near where the observation occurred in order to improve efficiency and accuracy of reporting. Once the machine-readable code is scanned, the personal device can receive application data from an application server connected to the network. A log entry can be generated in the user interface by the personal internet device. The log entry can be used to input data regarding the observation.

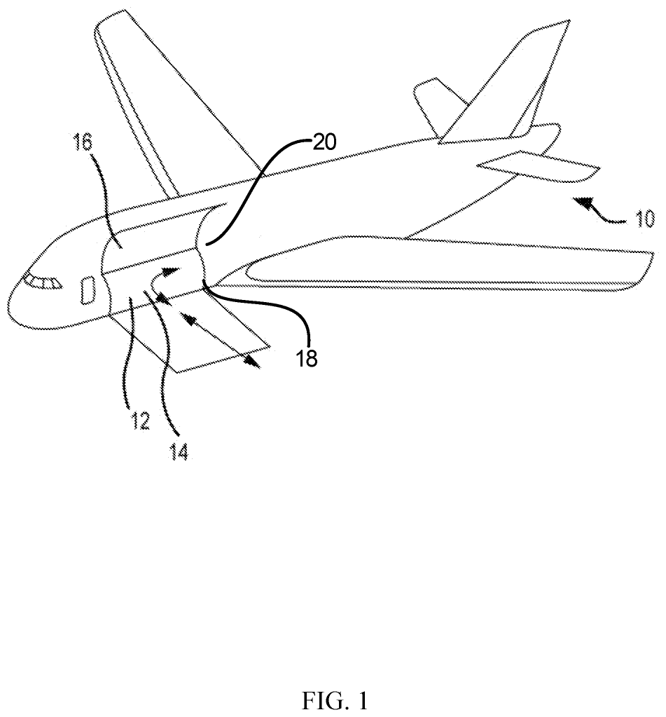

With reference to FIG. 1, a schematic view of an aircraft 10 having a cargo deck 12 located within a cargo bay 14 is illustrated, in accordance with various embodiments. The aircraft 10 may comprise a cargo load door 16 located, for example, at one side of a fuselage structure of the aircraft 10. After the aircraft 10 has reached its destination, aircraft personnel and crew can examine the cargo bay to determine if any observations need to be logged. A first code display 18 can be coupled to a wall 20 of the cargo bay 14.

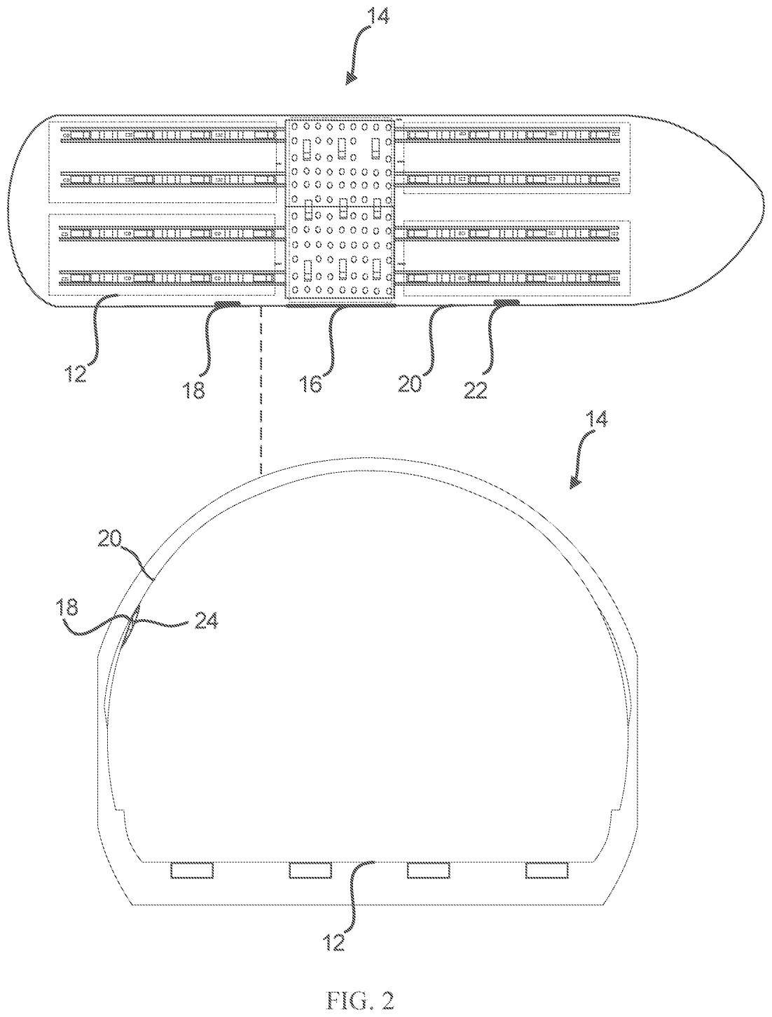

With continued reference to FIG. 2, a cutaway view of the cargo bay 14 is illustrated in accordance with various embodiments. A second code display 22 can also be coupled to the wall 20. The cargo bay 14 can have a plurality of code displays and the plurality of code displays can be dispersed throughout the cargo bay 14. The code displays 18 and 22 can be in an aircraft report zone such as a luggage compartment or a landing gear compartment. There can be multiple aircraft report zones throughout the aircraft 10, and each aircraft report zone can be a specific area of the aircraft 10 where the first code display 18 and the second code display 22 are disposed. Other examples of aircraft report zones can include a galley, a lavatory and a flight cabin.

In various embodiments, the first code display 18 can be a placard which is coupled to the wall 20 with a machine-readable code 24 painted or printed on to the placard. In various embodiments, the second code display 22 can be a placard which is coupled to the wall 20 with a second machine-readable code 26 painted or printed on to the placard. The code displays 18 and 22 can also comprise a section of the wall 20 where the machine-readable codes 24 and 26 are directly painted or laser etched on the wall 20. The machine-readable codes 24 and 26 can also be embedded in the wall 20 such that a personal internet device could use an RFID reader or a NFC reader to scan the machine-readable codes 24 and 26.

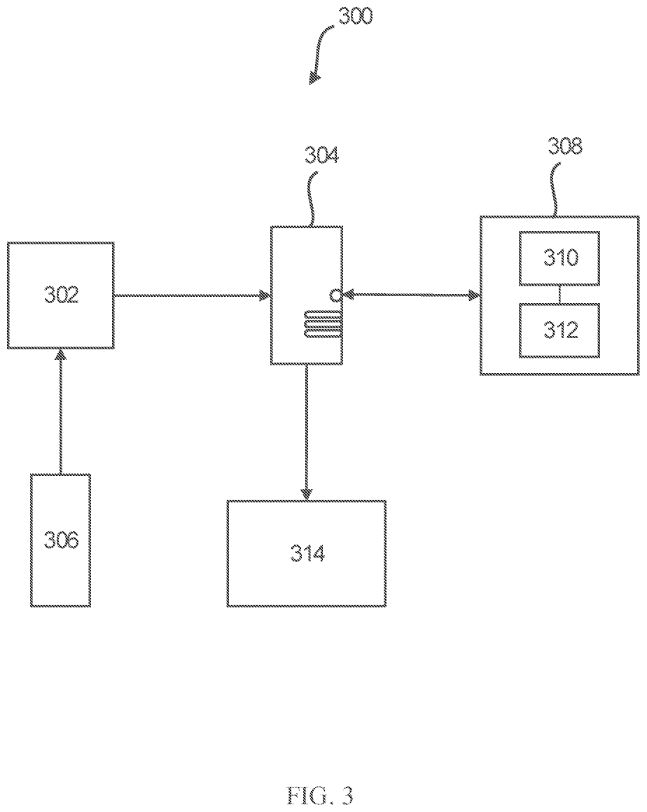

With reference to FIG. 3, a block diagram for an aircraft log system 300 is illustrated in accordance with various embodiments. The aircraft log system 300 can comprise a personal internet device 302 in communication with a network 304. The aircraft log system 300 can also comprise a machine-readable code 306 disposed on a code display, such as the code displays 18 and 22 on aircraft 10. There can be a plurality of machine-readable codes 306 disposed throughout the aircraft in the various aircraft report zones as disclosed above, including the galley, the lavatory, the flight cabin and anywhere else aircraft personnel may examine the aircraft.

The aircraft log system 300 can also comprise an application server 308 in communication with the network 304. The machine-readable codes 306 are configured to direct the personal internet device 302 over the network 304 to transmit an observation log request to the application server 308 after the personal internet device 302 scans the machine-readable code 306. The application server 308 can transmit an application data to the personal internet device 302 in response to receiving the observation log request. The application data can instruct the personal internet device 302 to open a user interface. The user interface can be a graphical user interface (GUI) which can allow a user to generate a log entry from the personal internet device 302. The log entry can comprise a pre-populated data and a user input data.

The pre-populated data can comprise unique identifiers associated with the machine-readable code 306. The pre-populated data can autofill the log entry with an aircraft report zone and an aircraft identifier to identify the aircraft. The aircraft report zone can comprise text describing the location of the aircraft report zone where the machine-readable code 306 was scanned by the personal internet device 302. The aircraft identifier can comprise a tail number of the aircraft, an aircraft serial number, an aircraft registration number and an aircraft model number. In various embodiments, the pre-populated data can also comprise an observation date and an observation time in which the personal internet device 302 scanned the machine-readable code 306.

Knowing the location of the aircraft can also be helpful in determining which maintenance personnel needs to service the aircraft. In various embodiments, the personal internet device 302 can comprise a global positioning system (GPS) receiver. GPS is a network of satellites that orbit Earth and can pinpoint the geographic location of a device using wireless signals. An aircraft location can be determined from a GPS location of the personal internet device 302 if location services are enabled for the personal internet device 302 in response to personal internet device 302 scanning the machine-readable code 306. If the network can access the GPS location of the personal internet device 302, then the pre-populated data comprises the aircraft location which will autofill into the log entry as the GPS location.

The user input data can comprise a log description, a notification request, and a name. The user input data can further comprise image data to display the observation or maintenance task. Also, the user input data can further comprise video data to display the observation or maintenance task. The image data can be photos stored locally on the personal internet device 302, and the video data can be videos stored locally on the personal internet device 302. In various embodiments, the personal internet device 302 does not have a GPS, thus the user input data can comprise the aircraft location. The aircraft location can be an airport code where the airplane is located.

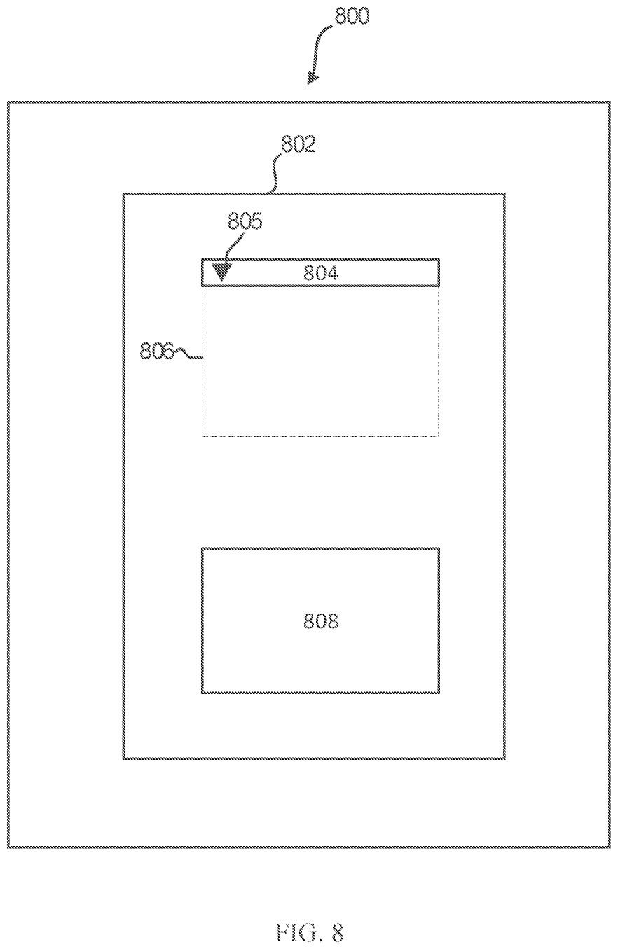

With reference to FIG. 8, an exemplary user interface is shown. The user interface 800 can be opened on the personal internet device 302. The user interface 800 can comprise a log description 802. In various embodiments, the log description can comprise a structured description 804 and an unstructured description 808. The unstructured description 808 can display an empty text field for the user to draft a free text description of the observation or maintenance task being reported. The structured description 804 can comprise a drop-down selection button 805. When the drop-down selection button 805 is selected a drop-down menu 806 can display a list of observations on the personal internet device 302. The list of observations can comprise a list of known and common observations and maintenance tasks to report. In various embodiments, the log description can comprise both or just one of the structured description and the unstructured description.

In various embodiments, the user interface can display a check box for the notification request. In response to the check box for the notification request being selected, the log entry is transmitted to the application server 308, then the application server 308 may generate an alert notification. In various embodiments, the application server 308 can transmit the alert notification to an aircraft maintenance system. Aircraft personnel can receive the alert notification from the aircraft maintenance system and can then review the log entry to address the observation.

The application server 308 can comprise a processor 310, and an aircraft log database 312. The processor 310 may include one or more logic devices such as one or more of a central processing unit (CPU), an accelerated processing unit (APU), a digital signal processor (DSP), a field programmable gate array (FPGA), an application specific integrated circuit (ASIC), or the like. In various embodiments, the processor 310 may further include any non-transitory memory known in the art. The aircraft log database 312 may store instructions usable by the logic device to perform operations. Any appropriate computer-readable type/configuration may be utilized as the aircraft log database 312, any appropriate data storage architecture may be utilized by the aircraft log database 312, or both.

The aircraft log database 312 may be integral to the application server 308 or may be located remote from the application server 308. The processor 310 may communicate with the aircraft log database 312 via any wired or wireless protocol. In that regard, the processor 310 may access data stored in the aircraft log database 312. Furthermore, any number of conventional techniques for electronics configuration, signal processing and/or control, data processing and the like may be employed. Also, the processes, functions, and instructions may can include software routines in conjunction with processors, etc.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

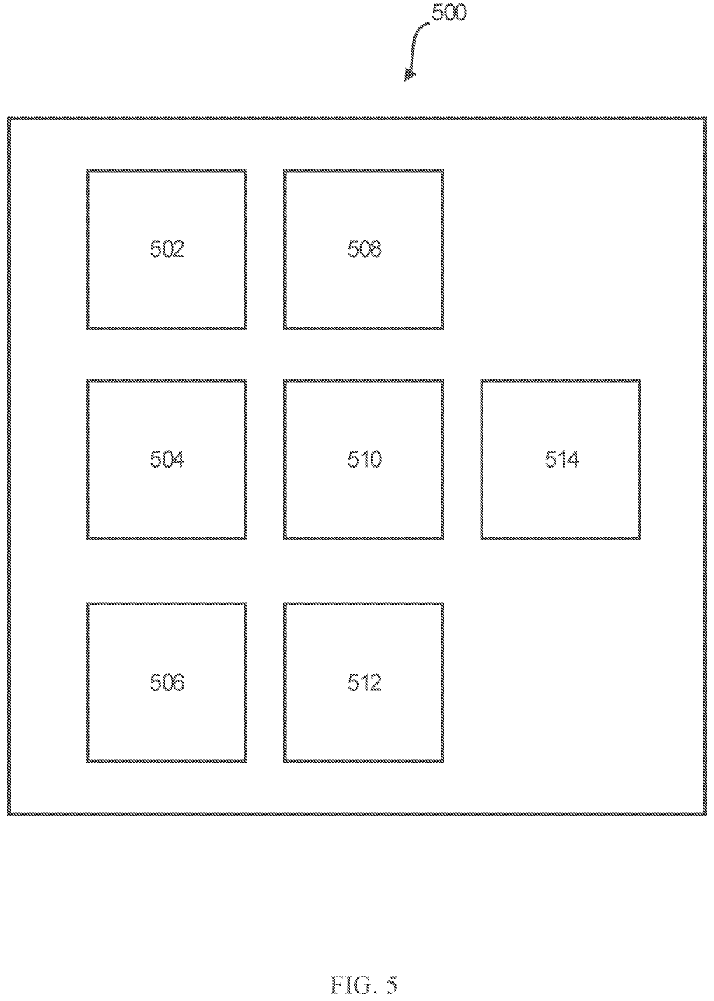

With additional reference to FIG. 5, a block diagram for the components of a log entry 500 is illustrated in accordance with various embodiments. The log entry 500 can comprise an observation date 502, an aircraft report zone 504 as described above, an aircraft identifier 506 as described above, an aircraft location 508, a name 510, a notification request 512, and a log description 514 as described above. All the data in the log entry 500 can be used to log observations and maintenance tasks discovered on the aircraft.

A first airline may comprise a first plurality of aircraft and the first plurality of aircraft can all record and track their log data in a first aircraft log database. Consolidating the data coming from the plurality of aircraft can allow for tracking of data trends. A second airline may comprise a second plurality of aircraft and want to record and track their data in a second aircraft log database. Both the first airline and the second airline could be using the same model or type of aircraft. In instances like this, it would be beneficial for the aircraft system manufacturer of the first plurality of aircraft and the second plurality of aircraft to also keep records of the log data. Therefore, a manufacture log database could be useful in tracking trends in the log data to make adjustments and/or maintenance recommendations to the aircraft fleet and to keep data from the first airline and the second airline separate and confidential.

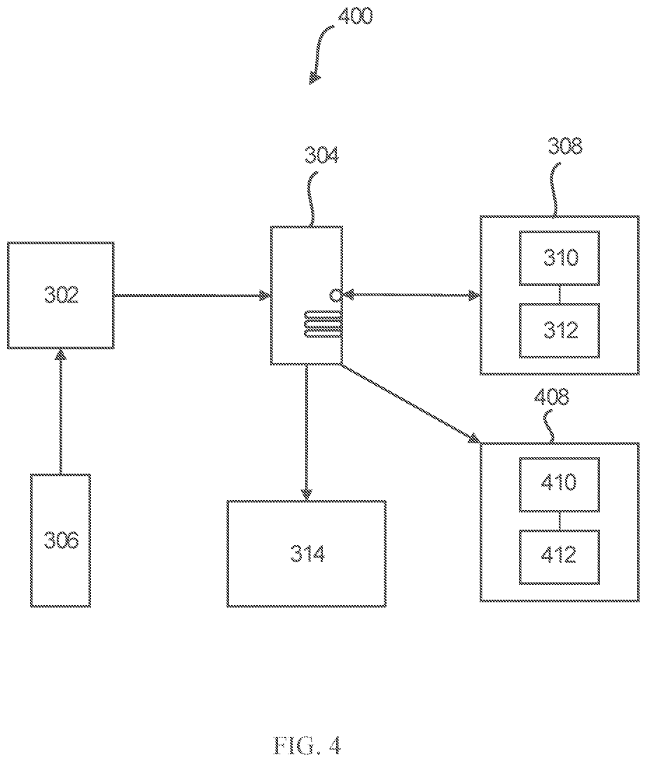

With additional reference to FIG. 4, a block diagram for an aircraft log system 400 is illustrated in accordance with various embodiments. The aircraft log system 400 can include all the components of aircraft log system 300, and the aircraft log system 400 can additionally include a manufacturer server 408 in communication with the network 304 and the application server 308.

The manufacturer server 408 can comprise a processor 410, and a manufacturer log database 412. The processor 410 may include one or more logic devices such as one or more of a central processing unit (CPU), an accelerated processing unit (APU), a digital signal processor (DSP), a field programmable gate array (FPGA), an application specific integrated circuit (ASIC), or the like. In various embodiments, the processor 410 may further include any non-transitory memory known in the art. The manufacturer log database 412 may store instructions usable by the logic device to perform operations. Any appropriate computer-readable type/configuration may be utilized as the manufacturer log database 412, any appropriate data storage architecture may be utilized by the manufacturer log database 412, or both.

The manufacturer log database 412 may be integral to the manufacturer server 408 or may be located remote from the manufacturer server 408. The processor 410 may communicate with the manufacturer log database 412 via any wired or wireless protocol. In that regard, the processor 410 may access data stored in the manufacturer log database 412. Furthermore, any number of conventional techniques for electronics configuration, signal processing and/or control, data processing and the like may be employed. Also, the processes, functions, and instructions may can include software routines in conjunction with processors, etc. The processor 410 can be configured to receive the log entry 500 from the network 304 via the personal internet device 302 and the application server 308. The processor 410 can store the log entry 500 on the manufacturer log database 412.

In various embodiments, the aircraft personnel may be required to login to a secure portal before recording data in the log entry 500. Login pages originating at a web client may pass through a firewall in order to prevent unauthorized access from users of other networks. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component

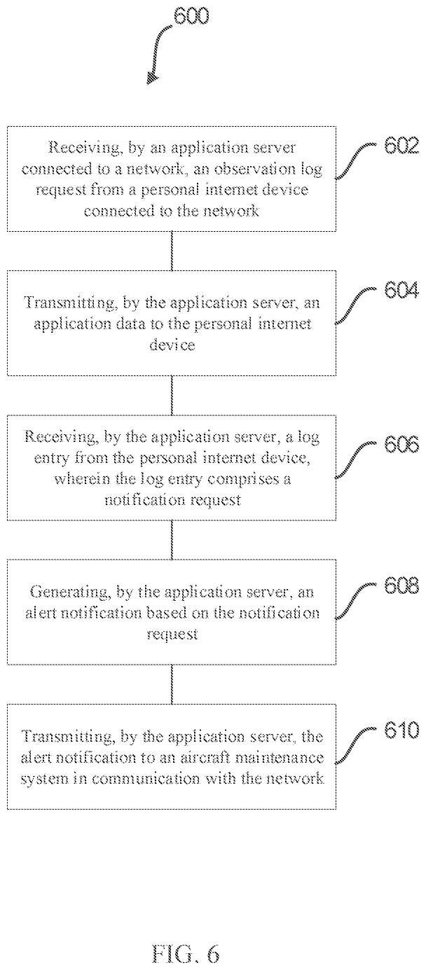

With reference to FIG. 6, a method 600 for logging an observation of an aircraft is shown. The method may comprise receiving, by an application server (shown as application server 308) connected to a network (shown as network 304), an observation log request from a personal internet device (shown as personal internet device 302) connected to the network (step 602). The observation log request can be transmitted from the personal internet device in response to scanning a machine-readable code (shown as machine-readable code 306). The personal internet device can scan a machine-readable code and translate the machine-readable code into a command for the personal internet device to transmit the observation log request to the application server.

In various embodiments, the method 600 may comprise transmitting, by the application server, an application data to the personal internet device (step 604). The application data can comprise any type of data disclosed above. The application data can instruct the personal internet device to open a user interface. Any data recorded in the user interface can create a log entry (shown as log entry 500). In various embodiments, the method 600 may comprise receiving, by the application server, the log entry from the personal internet device, wherein the log entry comprises a notification request (shown as notification request 512) (step 606). In various embodiments the log entry may not have a notification request. The log entry can comprise any type of data disclosed above. In various embodiments, the method 600 may comprise generating, by the application server, an alert notification based on the notification request (step 608). The alert notification can comprise data which can include text describing an alert and instructions for the device to turn on a notification signal.

In various embodiments, the method 600 may comprise transmitting, by the application server, the alert notification to an aircraft maintenance system (shown as aircraft maintenance system 314) in communication with the network (step 610). If the notification request is not selected in the log entry, then the alert notification is not transmitted to the aircraft maintenance system. The aircraft maintenance system can then display the alert notification to aircraft personnel to instruct them that the aircraft needs maintenance.

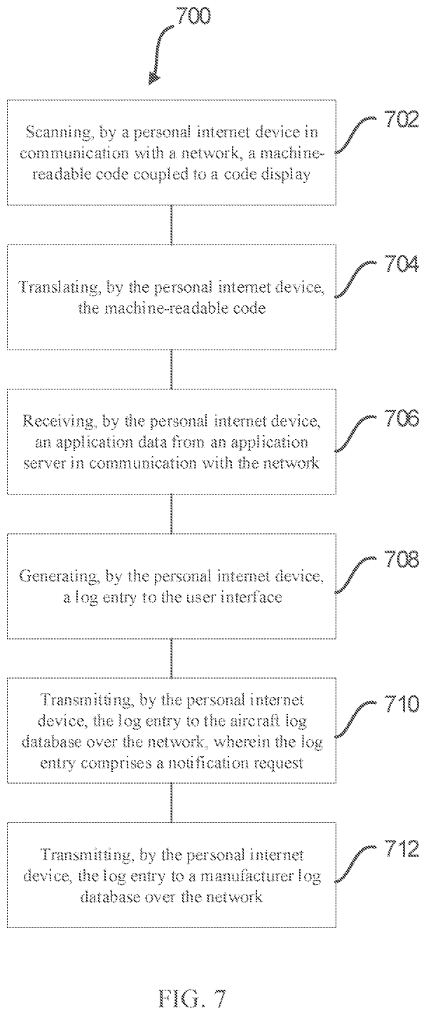

With reference to FIG. 7, a method 700 for logging an observation for an aircraft is shown. The method may comprise scanning, by a personal internet device (shown as personal internet device 302) in communication with a network (shown as network 304), a machine-readable code (shown as machine-readable code 306) coupled to a code display (shown as code display 18) (step 702). The personal internet device can scan any kind of machine-readable code as described above. In various embodiments, the method 700 may comprise translating, by the personal internet device, the machine-readable code (step 704). The machine-readable code can comprise data for the personal internet device, including instructions to transmit an observation log request across the network. The personal internet device may transmit the observation log request to an application server in communication with the network. The application server can be configured to, in response to receiving the observation log request, transmit an application data across the network. In various embodiments, the method 700 may comprise receiving, by the personal internet device, the application data from the application server (shown as application server 308) (step 706). The application data can instruct the personal internet device to open a user interface. In various embodiments, the method 700 may comprise generating, by the personal internet device, a log entry (shown as log entry 500) in the user interface (step 708). In various embodiments, the method 700 may comprise transmitting, by the personal internet device, the log entry to an aircraft log database over the network.

In various embodiments, the log entry can comprise a notification request (step 710). In various embodiments the log entry may not have a notification request. The log entry can comprise any type of data disclosed above. In various embodiments, the method 700 can comprise transmitting, by the personal internet device, the log entry to a manufacturer log database (shown as manufacturer log database 412) over the network. The manufacturer log database can analyze the data in the log entry to determine trends throughout the fleet of aircraft. The manufacturer log database can compare the log description submitted with each log entry to determine if a common observation or issue is reoccurring throughout the fleet of aircraft.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures.

The scope of the disclosures is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiment

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method of logging an observation of an aircraft, comprising:
receiving, by an application server connected to a network, an observation log request from a personal internet device connected to the network;
transmitting, by the application server, an application data to the personal internet device;
receiving, by the application server, a log entry from the personal internet device, wherein the log entry comprises a notification request;
generating, by the application server, an alert notification based on the notification request; and
transmitting, by the application server, the alert notification to an aircraft maintenance system in communication with the network.

2. The method of claim 1, wherein the log entry comprises a user input data and a pre-populated data.

3. The method of claim 2, wherein the user input data comprises a log description, the notification request, and a name.

4. The method of claim 3, wherein the pre-populated data comprises an aircraft report zone, an aircraft identifier, an observation date, and an observation time.

5. The method of claim 4, wherein the personal internet device comprises a global positioning system (GPS) location.

6. The method of claim 5, wherein the pre-populated data comprises an aircraft location based upon the GPS location of the personal internet device.

7. The method of claim 6, wherein the user input data and the pre-populated data comprise extensible markup language (XML) data.

8. The method of claim 7, wherein the log description comprises an unstructured description, wherein the unstructured description comprises a free text description of the observation.

9. The method of claim 7, wherein the log description comprises a structured description, wherein the structured description comprises a drop-down menu for selecting the observation from a list of observations.

10. A method of logging an observation for an aircraft, comprising:
scanning, by a personal internet device in communication with a network, a machine-readable code coupled to a code display;
translating, by the personal internet device, the machine-readable code;
receiving, by the personal internet device, an application data from an application server in communication with the network, wherein the application data instructs the personal internet device to open a user interface;
generating, by the personal internet device, a log entry in the user interface; and
transmitting, by the personal internet device, the log entry to an aircraft log database over the network, wherein the log entry comprises a notification request.

11. The method of claim 10, wherein the log entry comprises a user input data and a pre-populated data.

12. The method of claim 11, wherein the user input data comprises a log description, the notification request, and a name.

13. The method of claim 12, wherein the pre-populated data comprises an aircraft report zone, an aircraft identifier, an observation date, and an observation time.

14. The method of claim 13, wherein the personal internet device comprises a global positioning system (GPS) location.

15. The method of claim 14, wherein the pre-populated data comprises an aircraft location based upon the GPS location of the personal internet device.

16. The method of claim 15, wherein the user input data and the pre-populated data comprise extensible markup language (XML) data.

17. The method of claim 16, further comprising transmitting, by the personal internet device, the log entry to a manufacturer log database over the network.

18. An article of manufacture including a tangible, non-transitory computer-readable storage medium having instructions stored thereon that, in response to execution by a processor, cause the processor to perform operations comprising:
receiving, by the processor, an observation log request from a personal internet device connected to a network;
transmitting, by the processor, an application data to the personal internet device;
receiving, by the processor, a log entry from the personal internet device, wherein the log entry comprises a notification request;
generating, by the processor, an alert notification based on the notification request; and
transmitting, by the processor, the alert notification to an aircraft maintenance system in communication with the network.

19. The article of manufacture of claim 18, wherein a manufacturer log database in communication with the article of manufacture.

20. The article of manufacture of claim 19, wherein the operations further comprise transmitting, by the processor, the log entry to the manufacturer log database.
